(19) United States
(12) Patent Application Publication
(10) Pub. No.: US 2003/0149779 A1
(43) Pub. Date: Aug. 7, 2003

(54) Method and apparatus utilizing pin numbers for selectively providing digital goods

(76) Inventors: Gary Adelman, New York, NY (US); Dan Brodsky, New York, NY (US)

Correspondence Address: Joseph F. Murphy, Law Offices of Joseph F. Murphy, 101 West 23rd Street #2367, New York, NY, 10011-2490, US

(21) Appl. No.: 10/145,197

(22) Filed: May 13, 2002

Related U.S. Application Data
(60) Provisional application No. 60/290,534, filed on May 11, 2001.

(51) Int. Cl. G06F 15/16; G06F 17/60

(52) U.S. Cl. 709/229; 705/14; 709/203; 709/219

(57) ABSTRACT

An improved method and apparatus utilizing PIN numbers for selectively providing digital goods from a content provider to number to a consumer who has a PIN number and is at a client server.

### CROSS-REFERENCE TO RELATED APPLICATION

This application claims the priority of U.S. provisional patent application No. 60/290,534 filed on May 11, 2001; the entire contents of said provisional patent application are hereby incorporated by reference.

### FIELD OF THE INVENTION

This invention is in the field of distributing digital goods.

### BACKGROUND OF THE INVENTION

In recent years, the growth of the Internet has made possible the distribution of “digital goods”. These digital goods, which may comprise any item (e.g. a URL, audio file, web page, picture, etc.) contained as a flow of electronic information over the Internet, are typically delivered to a consumer at a “client” computer, from a larger “server” computer. The Consumer Client Computer may be virtually any device having or being operated in conjunction with a microprocessor (e.g. a Personal Computer, an MP3 player, a Palm Computer, etc.) Distributors of digital goods need to selectively distribute digital goods to consumer client computers. In prior art attempts to solve this problem, distribution might be permitted, for example, when a consumer enters a PIN number corresponding to a digital good displayed on a storefront web page, and that PIN number is validated by the server, which authorized the distribution of the digital goods. One disadvantage of this prior art was that enabling the function of validation had to be to be done at the server level, rather than at the level of the web page; therefore a person who had created an ordinary webpage, e.g. such as one hosted on an ISP server, could not include PIN validation on his site, as such a person could only write code on the webpage, and could not modify the server software itself.

According to the method of the present invention, however, simple HTML code and JavaScript employed at the web page level will transfer an entered PIN number to a special PIN number manager server, which will validate the PIN, and, when appropriate, permit the distribution of the digital good, e.g., by allowing a direct download, or by redirecting the consumer client computer's browser program to another URL location at which the digital good would be distributed to the consumer. Thus, in one aspect of the invention, it allows a web page author of a storefront webpage to “virtually outsource” the PIN validation function, and to obtain benefits of it without having to operate on the server software itself.

Other advantages obtain from the approach of the present invention. For but one example, the dedicated functionality of the PIN management computer not only performs the validation functions, but also enables detailed data collection and reporting of the PIN-enabled distribution transactions.

To appreciate benefits obtained according to the method and apparatus of the current invention, consider that the continued increase in the number of websites on the Internet presents digital goods creators (hereinafter sometimes referred to as a CONTENT PROVIDERs or CPs) with an increased opportunity to distribute their digital goods while at the same time crowding their marketplace and making it harder for them to connect with consumers. With so many possible destination websites for a consumer to go to, it has been an increasing problem for the operator of a given website to get consumers to come to his website—to “drive traffic” to his website, in the common idiom.

It is important to consider what is involved in driving traffic to a website. To drive traffic to a website one must cause a consumer to enter the URL of the destination website into his or her browser. Getting the consumer to do this is no small task, as it requires several things: (1) Exposing the consumer to the URL; (2) getting the consumer to memorize or write down the URL so as to have it available for later entry into his or her browser; (3) Motivating the consumer to actually enter the URL into his browser and visit the destination website. Typically, promoters of websites resort to traditional advertising methods (radio, TV, billboard ads) But of all those who are exposed to the ads, only a small percentage will record or remember the URL, and only an even smaller percentage will actually enter the URL into the browser and visit the site. What is needed is a way to drive the distribution of digital goods.—The problems of (1) teaching the potential digital goods consumer the URL at which the digital goods may be found, (2) aiding said consumer in retaining the URL long enough to have it available for use, (3) motivating the user to actually enter the URL in his or her browser and visit the destination site being promoted, and (4) have a controlled delivery/distribution of the digital goods are all solved by the method of the present invention, which solves all the foregoing problems in a way that is strikingly simple, yet robustly effective, and which, moreover, offers numerous other advantages.

The method according to the present invention allows CONTENT PROVIDERs to REGISTER with DOWNLOADCARD.COM, to identify content (digital goods) in a fashion enabling the distribution of said digital goods to be managed by DOWNLOADCARD.COM; to have Personal Identification Numbers (PIN) numbers assigned to it for use in certain DownloadCards (described herein); the method further allows the consumer possessing the PIN (such as may be encoded on, for example, a DownloadCard), may have distributed to him certain files of digital goods, in accordance with the permissions the Content Provider has allocated as attribute(s) of the PIN. Furthermore, in accordance with the method according to the present invention, an authorized party can generate (using (i) an administrator module operatively connected with the database(s) of the DOWNLOADCARD computer or (ii) any other suitable means) many different reports, including but not limited to reports relating to the following: the actual or attempted download of content using a DOWNLOADCARD; what the download activity is with respect to one or more particular digital good(s); what is happening to particular content, or to a particular set of cards or PIN numbers, or to all content of a particular CONTENT PROVIDER, etc. Moreover, in further accordance with the practice of the current invention, various data from one or more of a plurality of CONTENT PROVIDERS may be aggregated, and used to generate reports or analyses suitable for benchmarking, resale to consumer market data companies, etc. In accordance with the practice of the present invention, a consumer is given a Personal Identification Number (PIN). According to the present invention, there is a PIN which allows the consumer to receive the digital good, and the provision of which, at a website (e.g. a digital goods storefront), causes a digital good to be delivered to the consumer, who has a digital good delivery (effectuated by direct file transfer, or by providing the consumer with a “secret” URL where the digital good is located, or by a redirecting the consumer to a “secret” URL where the digital good is located). Notably, however, the PIN need NOT be validated at the website at which it is presented; rather, validation occurs solely on the DOWNLOADCARD.COM site. Also notably, the content need not be warehoused on the digital storefront computer NOR even on the DOWNLOADCARD.COM computer (though either may be possible). Note further that the digital storefront server/digital goods purveyor need not have a back-end technology to provide this; this facilitates digital good distribution. The PIN is often (though certainly not always) marked on a card, e.g. what is sometimes referred to hereinafter as a “DownloadCard”—a small, ideally credit-card sized card which contains an advertisement listing the destination URL, and which has also has a PIN number which, used in conjunction with the URL, will enable the consumer to receive a premium—usually (though not always) a free one—for visiting the destination site (it bears emphasis that, while the examples given herein will largely illustrate the PIN as encoded onto a card, the PIN may be encoded onto other objects; indeed, the. PIN may be put on any type of promotional ephemera, e.g. on a mousepad, pencil, calendar, or in or on a breakfast cereal box, etc.—and of course the PIN number may be given to the consumer by non-physical means as well.) However, we will now use a DownloadCard as an example for a means of PIN transmission to the consumer; an example of this DownloadCard is depicted in FIG. 1.

### BRIEF DESCRIPTION OF THE DRAWING

FIG. 1 is a downloadcard.

FIG. 2 shows a screen with a registration form for a content provider to complete.

FIG. 3 shows an alternative screen with a registration form for a content provider to complete.

FIG. 4A shows a screen through which a content provider upload content provided.

FIG. 4B shows a screen through which a content provider may perform administrative functions.

FIG. 5 shows a screen through which a content provider may provide information relating to a downloadcard being created.

FIG. 6 shows a screen through which a content provider may select a downloadcard template.

FIG. 7 shows a screen through which a content provider may administer content.

FIG. 8 shows a screen displaying demographic information.

FIG. 9 shows a screen of an example storefront website.

FIG. 10 shows a screen of a popup window, where a consumer may enter a PIN number.

FIG. 11 shows a typical download beginning screen displayed after a PIN number is entered.

FIG. 12 shows a typical download in progress.

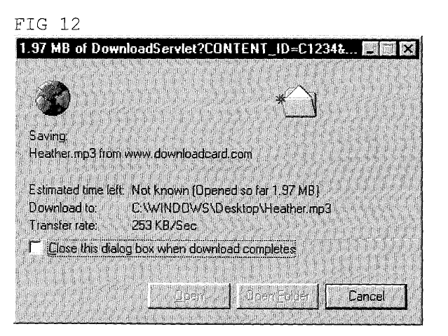

FIG. 13 shows a typical download beginning screen displayed after a PIN number is entered.

FIG. 14 shows the main screen of the administration module.

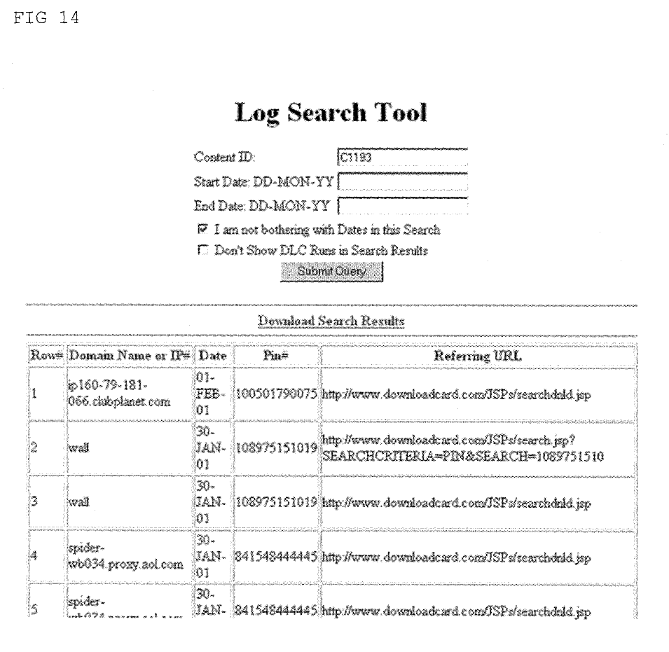

FIG. 15 shows one view of the Log Search Tool screen.

FIG. 16 shows another view of the Log Search Tool screen.

### DETAILED DESCRIPTION OF THE PREFERRED EMBODIMENTS

Once the consumer/user receives the downloadcard, he or she has been exposed to the URL of the destination site being promoted; in fact, he has been given a physical representation of this URL (along with a PIN number) in a way that will enable him to have a record of that URL and so can later enter it into his browser. Furthermore, the lure of a premium download using the PIN number found on the DownloadCard gives him an incentive to visit the destination website found at that URL. Moreover, he is also incentivized to register at said website, in order to receive the premium and/or additional or future premiums. Thus, the method according to the present invention solves the aforementioned problems addressed. However, still further benefits obtain from the practice of the method according to the present invention, as, for example, the consumer may be incentivized to return to the website for any number of reasons—such as a “recharge” of his card, the promise of another premium at another time, an/or by the simple fact that he is now a registered user at that site, and hence more easily to transact business of whatever kind there. Note that the examples given herein are giving in a non-limiting fashion, and other advantages will be readily apparent to those of ordinary skill in the art.

As will be seen herein, the method according to the present invention goes beyond merely solving the aforementioned problems and may be used to conduct a promotional campaign, track the results of that campaign, and obtain valuable data regarding buying behavior, and demographics. And even apart from its value in all that, it may be readily seen that the method according to the present invention facilitates the comprehensive distribution of digital goods—from the easy digital warehousing of such goods, to the attraction of consumers for such goods to the destination website being promoted, to distributing the digital goods, to rewarding those consumers to accept such goods and engage in continued online interactions with the site they were, in the first instance, lured to by DownloadCard; overall to warehouse and distribute digital goods.

Typically, a CONTENT PROVIDER website will want to increase the amount of traffic to its CONTENT PROVIDER destination web site) hereinafter sometimes referred to as CONTENT PROVIDER WEBSITE), and in particular to increase the number of unique visitors—now customers. CONTENT PROVIDER WEBSITE will want to enhance its “stickiness”—that is, the time a visitor spends on the site. The CONTENT PROVIDER WEBSITE will want to encourage registration of visitors to the site—thereby obtaining more demographic data about its pedestrians. While each of the above is not insurmountable in itself, each CONTENT PROVIDER WEBSITE is in competition with many other CONTENT PROVIDER WEBSITEs for the same potential visitors. This in part underscores the need for the present invention'.

Prior art attempts to solve the instant problems have involved schemes such as click-through banner ads, which, if (a big if) clicked on will enter the destination URL into the potential consumers browser—however these ads are so numerous they have a very low rate of response and are ignored, even resented, by online consumers. Certainly a “card” of one sort or another has been used for myriad things—see, e.g. U.S. Pat. No. 5,577,109, which discloses a pre-paid telephone card; while such a card itself might bear a facile resemblance to a DownloadCard (or indeed to any card which one might find in one's wallet) that patent, and its card, are directed at a totally different problem then the card used in the method of the present invention. Likewise, U.S. Pat. No. 5,774,869, which discloses a card facilitating free Internet access, is not part of a method such as the one of the present invention, which deals with digital goods, and U.S. Pat. No. 6,173,267 deals with using a card as a sweepstakes ticket, Thus, there has not been found any effective prior art solution that is as good as the method according to the present invention. No other method is known to be as potentially effective in facilitating the distribution of digital goods, as disclosed herein.

Considering further now the presently preferred method according to the current invention, is now useful to consider the role and position of CONTENT PROVIDERS. “CONTENT PROVIDERs” means any one who has any content managed by the DOWNLOADCARD PIN computer management system. Content includes, but is not limited to, e.g., files comprising music, software, games, and graphics files. CP's log in to the DOWNLOADCARD.COM home page, and then make their Digital Goods available to be selectively distributed to consumers, in accordance with the present invention. Typically, each digital good is assigned an identification number, and a value (which, in the case of promotional goods, may be zero).

Also they may be assigned a CP ID, and any other codes. The actual location where the digital goods are warehoused is not of the utmost importance, since, regardless of where the digital goods are, in accordance with the present invention they are accessed the same way, e.g. through the storefront webpage. Some Caps, e.g. those without their own website, may warehouse their goods at www.downloadcard/contentprovidername). If the CP has an existing website, it may well still keep its goods at a subdirectory of its own website, and still take full advantage of the PIN validation procedures according to the method and apparatus of the present invention by using the REDIRECTOR feature. Using the REDIRECTOR feature, the step of validating the PIN number will cooperate with a step which determines what the CONTENT ID associated with the PIN number is, i.e. it determines what file is to be distributed. According to the method of the present invention, it is also determined whether the file to be distributed is to be distributed by direct download or by using REDIRECTOR. If it is the latter, the applet etc. employed will return to the consumer a new “custom” URL to which the consumer may go (via browser, etc.) to have the digital good duly distributed to him or her. The text of this custom URL is corresponding to that PIN; moreover it is opened in its own separate browser window, a window which, by use of programming techniques well-known to those skilled in the art, is extremely difficult to bookmark, or at access by another when the another has not already had his PIN number validated and been provided the URL in accordance with the present invention.

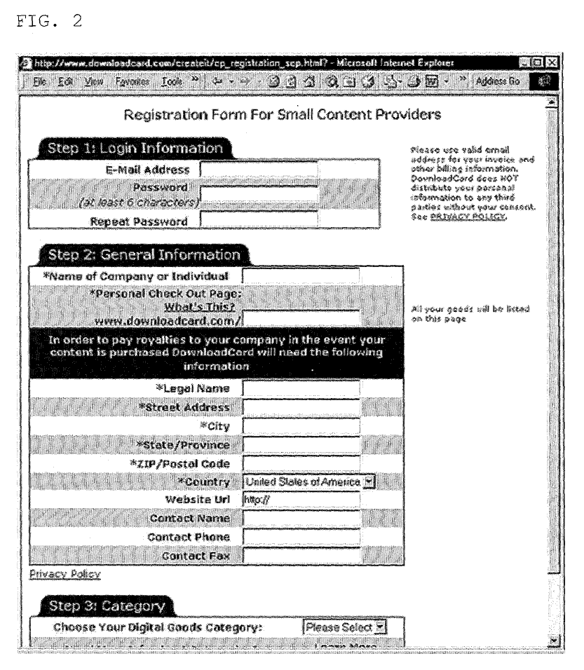

In accordance with the method of the present invention, a CONTENT PROVIDER will register with DownloadCard by going to a certain URL, e.g. http://www.downloadcard.com/createit/login.html. . An exemplary Registration form is shown in FIG. 2.

Referring to FIG. 2, note that a CP becomes a REGISTRANT by completing the registration form, supplying certain information such as their email address, billing address etc. When this is done, a password is created; the email address can be used to give the CP its password. The CP REGISTRANT must also leave a and create a PERSONAL CHECKOUT PAGE (typically, a subdirectory of www.downloadcard.com, e.g. www.downloadcard/contentprovidername or an HTTP link [to its own site, e.g. www.contentprovidername.com)

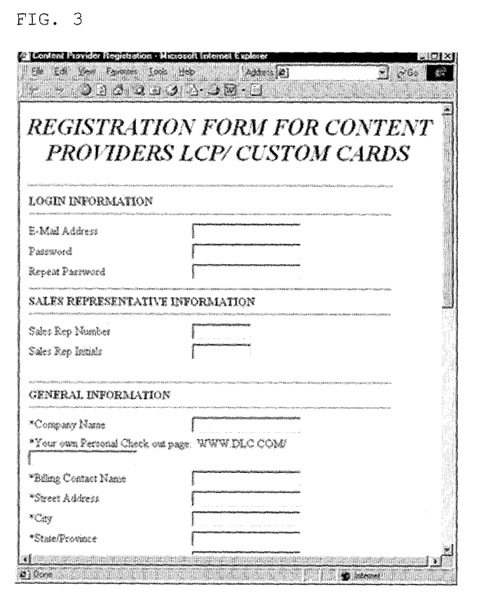

In an alternative embodiment that is a variation on the method of the current invention, registration may be mediated, not entirely by web interface, but with a traditional sales rep at DOWNLOADCARD.COM. In such a case, the registration screen might gather slightly different information, as indicated in FIG. 3.

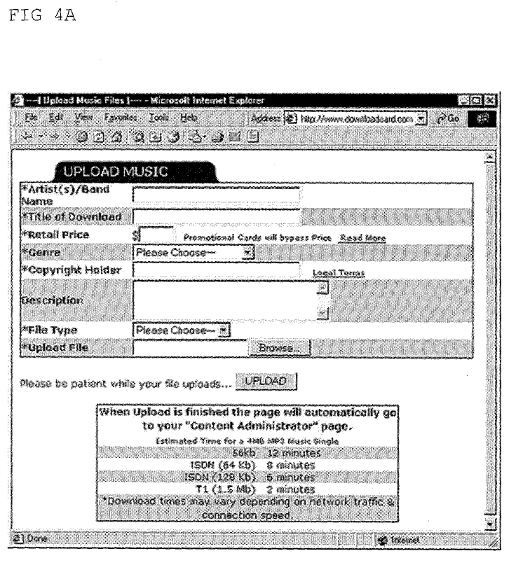

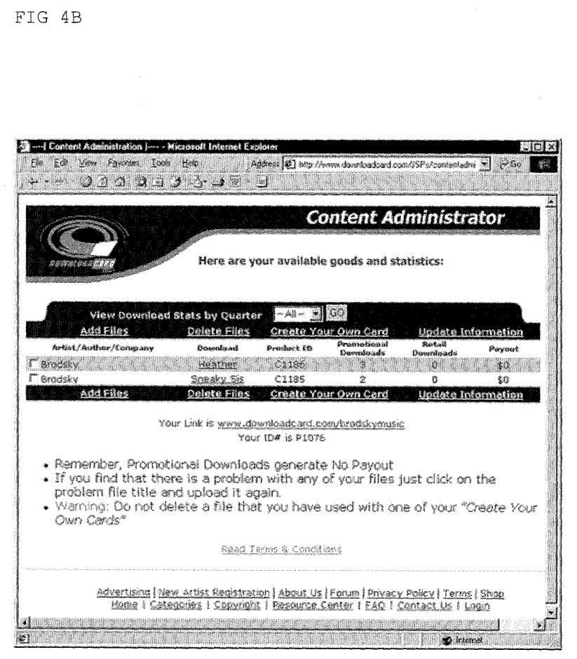

After REGISTRATION a CONTENT PROVIDER will, of course, need to upload that content in accordance with the method of the present invention. An exemplary screenshot showing how the content might be uploaded is given as FIGS. 4A and 4B; (note that program control may flow from FIG. 4A to FIG. 4B, as noted on screen in FIG. 4A.)

Note that each file uploaded has assigned to it certain identifiers, which may include, for example, a CONTENT ID (e.g. C1234) and a PROVIDER ID (e.g. P1023) are assigned.

CONTENT PROVIDERs also have their own PERSONAL CHECKOUT PAGE of the form www.downloadcard/contentprovidername.

CONTENT ADMINISTRATION REPORTING also provides statistics on promotional and retail card downloads and overall payout. Each PIN number is only counted once as a download statistic. Download statistics are all in real time and can be accessed accordingly when a CONTENT PROVIDER logs on.

CONTENT ADMINISTRATION allows for adding, updating, or deleting digital goods files. There are also repeated links, including links where CP's can ‘Create Your Own Card’, i.e. generate custom downloadcards, and links where CP's may modify information provided during Registration.

Adding a File: To add a file, CP's simply hit ‘Add Files’ and the content upload page will appear. Each CP user has an overall file. In the presently preferred method according to the present invention, CP Content upload (from ‘Add Files’ on content admin page) requires the following fields to be filled out:

Music: Fields might include: Artist/Band; DOWNLOAD TITLE; Price ($0 or greater); Copyright Data; Genre (linked on Category); Short Description; File Type (e.g., MP3, WAV or MID).

Text or book files have fields which might include, for example, Author; DOWNLOAD TITLE; Price ($0 or greater); Copyright Data; Genre (linked on Category); Short Description; File Type (e.g. PDF, DOC, TXT or ZIP) Once the CP uploads it, a file may of course be edited, deleted, or replaced; in each case the information in the affected field(s) will be updated and/ or replaced, as may be appropriate.

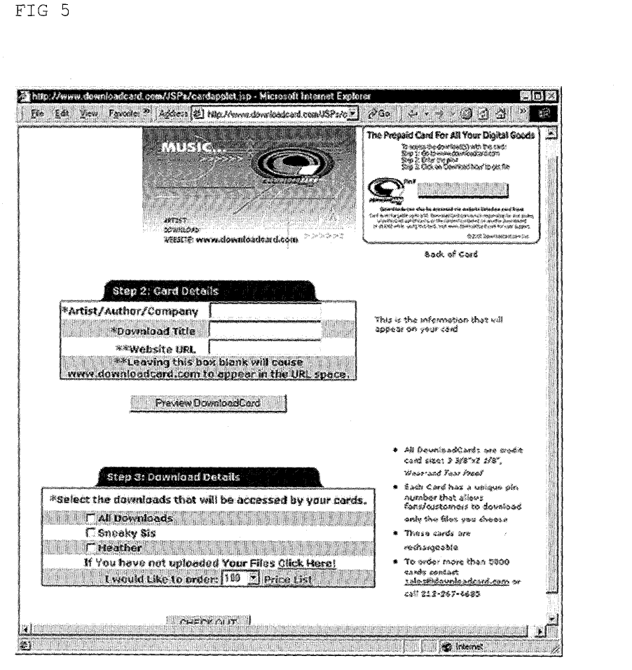

Turning now to FIG. 5, consider how, in accordance with the method and apparatus of the current invention, a CP may create its own custom card—a card that is customized both as to its appearance (artwork) as well as its content.

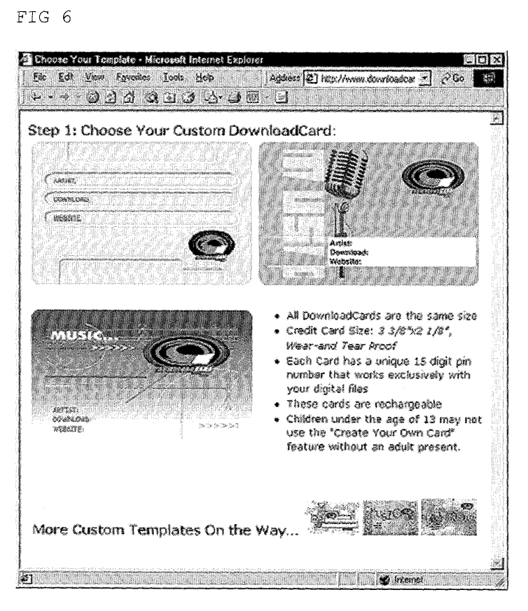

The customization process begins when, after registering, CP users login and choose ‘Create Your Own Card’. First they choose go to a “template page” entitled “Choose Your Custom Download Card (see FIG. 6) where they select for their own customization a pre-made template from those which were already printed and manufactured at DOWNLOADCARD card printers. (While, in this example only music templates are shown; this is for reasons of brevity, it being understood that there are other templates for other types of content.)

When a CONTENT PROVIDER chooses one of the templates to create downloadcards, it must choose which file(s) it would like the DownloadCard to be able to download. (Of course, if no digital goods files had yet been uploaded the CP user is instructed to upload such files before continuing. The upload page (from ‘Add Files’ on Content Admin) link is shown.)

After a template is chosen, the CP user then needs to enter relevant information, (such as, in the context of music) ARTIST NAME, DOWNLOAD TITLE, and WEBSITE that will appear on the card front. (Note that the website default is www.downloadcard.com.) These three fields will correspond to the download file associated with that particular DownloadCard which will bear a PIN number.

Note that if, in creating a particular downloadcard, a CP user does not name individual digital goods files, but merely lists “All Downloads”, then that downloadcard will enable the consumer (cardholder) to download, not only the files which the CP has already uploaded, but also any and all files which the CP may upload in the future. In other words, in this example, if a CP uploads a new file, the downloadcard's PIN number will also allow the cardholder (consumer) access to that newly-uploaded file. A DownloadCard with ‘All Downloads’ indicated can download, access, or otherwise use any digital goods file in the current CONTENT ADMINISTRATION file area.

Most commonly, however, CP users will not list “All Downloads” but will instead choose an individual file(s) that will work for the Card. These are specific files that will only work the DownloadCard. For example if a CP uploads, for example, digital goods files A, B, C, and chooses ‘All Downloads’ when creating the downloadcard, a card holder can download A, B, C. If the CP later uploads MP3 D, that card holder can download MP3 A, B, C and D. However, if a CP user, when creating the downloadcard chooses specific files, e.g. B &C then the Card Holder will only get those files. Alternatively, (not shown for brevity) the CP may specify not by file name, but by file type (e.g. PDF, MP3, etc.) what file may be distributed/made accessible by a particular downloadcard.

Next, the CP chooses the number of cards it wishes to order. An order number is then assigned, and a price is computed based on the volume desired. Finally, they proceed to Checkout: The user has to then choose a mode of payment—any of a number of ways, including, but not limited to, credit card, direct billing, etc.

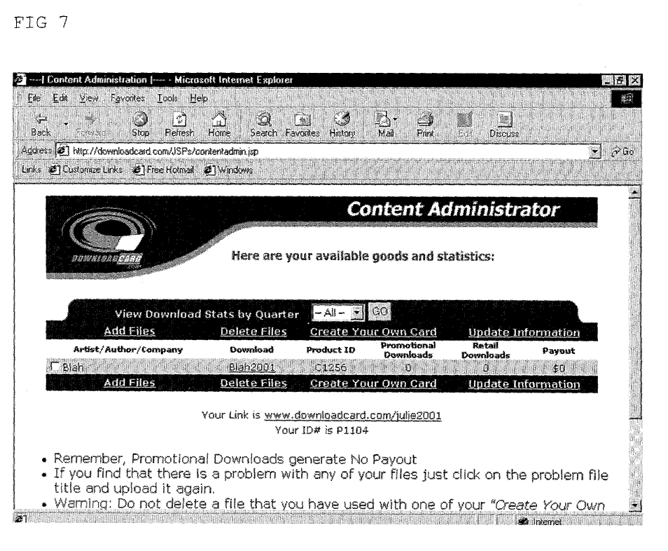

The Admin Module prints one file per order. This file contains rows of all attributes; these attributes may include: ARTIST NAME, DOWNLOAD TITLE, Website URL, Pin Number and CONTROL NUMBER; in this regard, see FIG. 7.

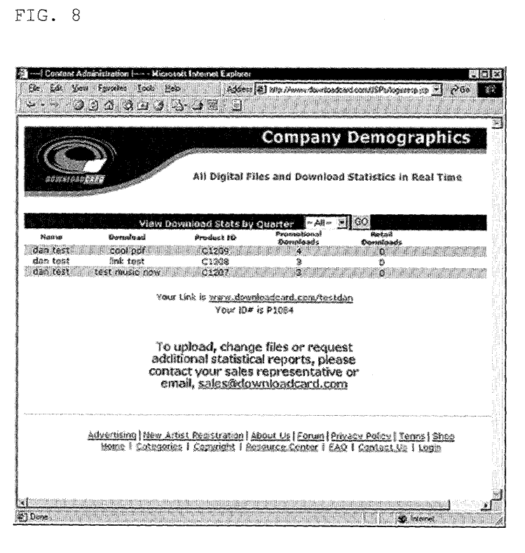

In an alternative embodiment, a CONTENT PROVIDER may have its information displayed more concisely, as shown in FIG. 8.

Authorized DOWNLOADCARD.COM personnel may edit the “catalog” of content that exists for each CONTENT PROVIDER. According to the method of the present invention, this is accomplished via an interface that is well-known to those skilled in the relevant arts. For example, adding a file is initiated simply by clicking “Add File”; deleting a file is accomplished by checking the file to be deleted and clicking “delete file”; changing a file is accomplished by click-selecting on the file name and uploading the changed file.

The following paragraphs show how a consumer with the appropriate PIN—(e.g., a consumer holding a downloadcard bearing the appropriate PIN) may have digital goods corresponding to the PIN distributed to the consumer client computer. (It must be noted that the consumer client computer can be any microprocessor-based device, including, for example, a Personal Computer, a Palm Pilot, a Diamond Rio MP3 player, etc.) Typically, a PIN number is entered into a pop-up window. In this regard,

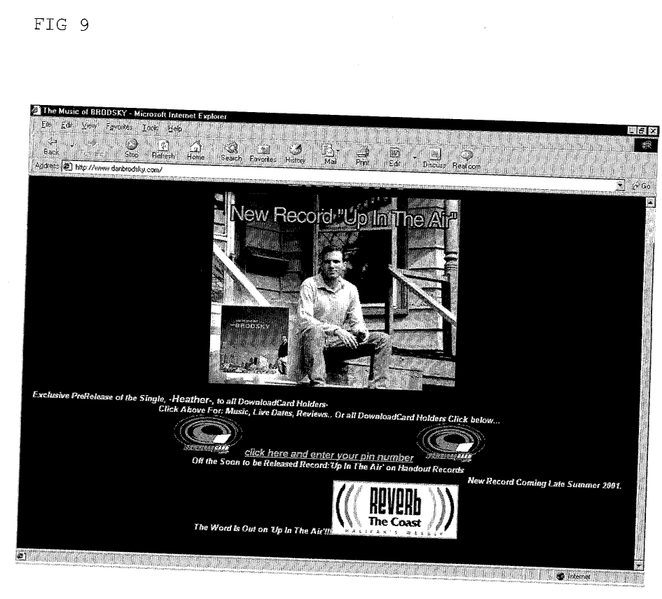

Reference is now made to FIG. 9, which was generated by the following HTML code:

<!DOCTYPE HTML PUBLIC “-//W3C//DTD HTML 3.2 Final//EN”>
<HTML>
<HEAD>

<TITLE>The Music of BRODSKY</TITLE>

```
<meta http-equiv=“Page-Enter”
content=“blendTrans(Duration=3.0)”>
<meta http-equiv=“Page-Exit” content=“blendTrans(Duration=3.0)”>
<meta http-equiv=“Site-Enter”
content=“blendTrans(Duration=3.0)”>
<meta http-equiv=“Site-Exit” content=“blendTrans(Duration=3.0)”>
</HEAD>
<script language=‘javascript’>
function PopMeter(URL)
{
  var name = “dcw”
  var other =
“toolbar=no,directories=no,menubar=no”;
  other += “,status=no,width=500,height=500”;
  open(URL, name, other);
}
</script>
<BODY bgcolor=“Black” link=“#ff9933” alink=“#ff9933”
vlink=“#ff9933” ><table height=100% width=100%><tr><td
align=“CENTER” valign=“MIDDLE”>
<center><img src=“images/welcome2.gif”>
<center><a href=“index01.html”>
<img src=“images/01 copy.jpg” width=400 height=309 alt=“click
here to enter” border=“0”>
</center></a><br><center>
<font face=“News Gothic T, arial” color=“#ffffff”><b><font size=“3”>
<i><b><i><marquee>Exclusive PreRelease of the Single,</i><big>
-Heather-</big><i>, to all DownloadCard Holders-
</marquee><br><font size=“3”>Click Above For: Music, Live Dates,
Reviews.. Or all DownloadCard Holders Click below... </font><br>
<img src=“images/logo_dlc[1].gif” width=“112” height=“63”>
<font size=“4”><a
href=“javascript:PopMeter(‘http://www.downloadcard.com
/JSPs/searchdnld.jsp?&CONTENT_ID=C1234’);“>click
here and enter your PIN number</a>
</b><img src=“images/logo_dlc[1].gif” width=“112”
height=“63”></img></i><br>
<font size=“3”><b>Off the Soon to be Released Record:<b>‘Up In
The Air’ on Handout Records</b>
<font size=“3”><br>
<i><marquee>New Record Coming Late Summer
2001.</marquee></i><br>
<font size=“3”> The Word Is Out on ‘Up In The Air’!!!</big><a
href=“/reviewsframe.html”><img src=“images/coast.gif”></img></a>
<br><p>
</center>
</td></tr></table>
</BODY>
</HTML>
```

The method according to the present invention was accomplished by adding only a few lines of code (highlighted above) i.e.

```
<script language=‘javascript’>
function PopMeter(URL)
{
  var name = “dcw”;
  var other =
“toolbar=no,directories=no,menubar=no”;
  other += “,status=no,width=500,height=500“;
  open(URL, name, other);
}
- and -
href=“javascript:PopMeter(‘http://www.downloadcard.
com/JSPs/searchdnld.jsp?&CONTENT_ID=C1234’);”>
click here and enter your PIN number</a>
```

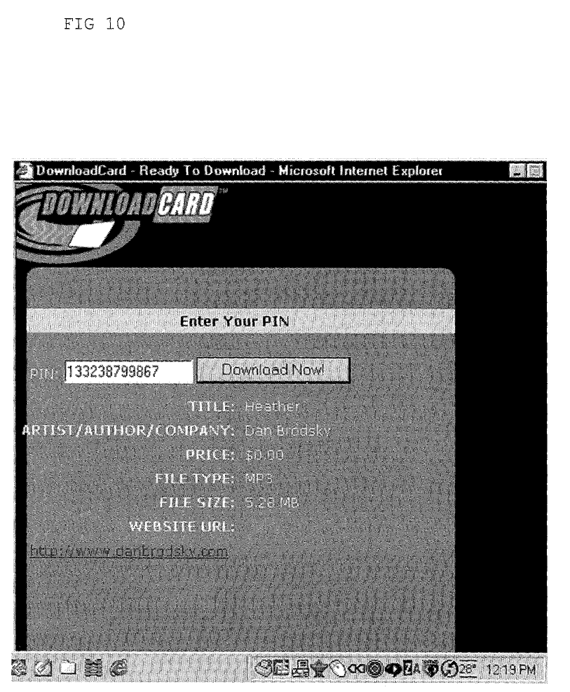

The addition of the foregoing code allows the webpage to use JSPs as “messengers” and call upon the functionality of the PIN so that the window shown in FIG. 10 will pop up, and (as shown) the consumer may enter his PIN number in the space provided.

Once the PIN is entered, a consumer (using, for example, the Microsoft Internet Explorer browser), will be presented with the dialog box shown in FIG. 10.

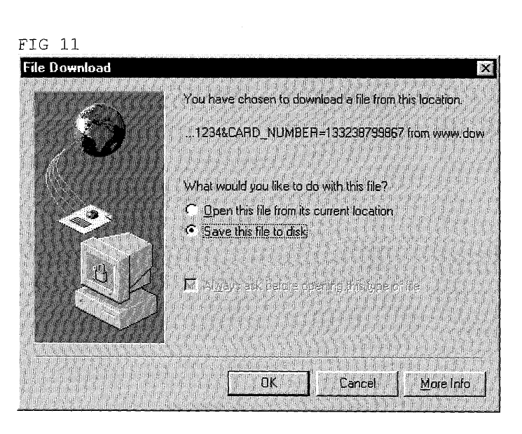

Once the user selects “save this file to disk”, he or she will be presented with a pop-up box indicating the download is in progress. A snapshot of such a dialog box, taken during an actual download, is shown in FIG. 11.

An additional feature of the method of the present invention is REDIRECTOR, by which a CP may distribute digital goods using an http link on its own site in addition to uploading a file to the DownloadCard site. Clients can choose to direct cardholders to their website (most likely to a subdirectory thereof which is otherwise not easily publicly accessed), or to a third party site (which, similarly, is otherwise not easily publicly accessed). A link must have the correct format http://www.mysite.com for it to work properly. That link is somewhat hidden in a JSP tags. This link is used for files located on another site, or just an entrance into another website. That field will be enhanced to possibly offer a way to make sure that cardholder does see the link or a special password protected FTP area.

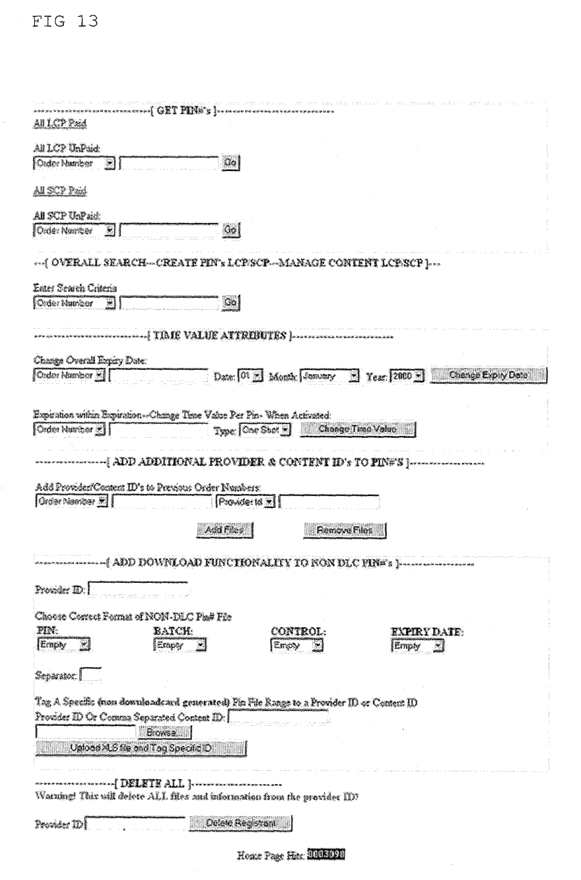

We will now describe the Administration Module used in the preferred embodiment of the current invention; the Admin Module's main screen is depicted in FIG. 13. First, consider Pin Generation: Once an order for cards is taken, it will be apparent that there will need to be generated a set of PIN numbers, one corresponding to each card. This set of PIN numbers is stored in a single file, which may be generated by a number of means. In the presently preferred method known software techniques are employed to generate each of a plurality of random or pseudorandom numbers, which are typically large integers, in the quantity needed. (Of course, any pre-existing set of numbers could be used, e.g. student ID numbers, etc. as might befit certain applications.) According to the presently preferred practice of the invention, the PIN numbers are unique for each downloadcard; however it is possible that non-unique numbers could be used in certain applications. Note that each PIN number has associated with it certain ATTRIBUTES; an ATTRIBUTE is a value such as a time frame, a download, access to an area, points in a game/contest, etc.

Pin Number Expiration or Termination is now considered.

A PIN number may lose its functionality on an arbitrarily set Expiration Date, unless it is terminated beforehand, e.g. a “one-shot” single-use PIN number will terminate after its single use, regardless of the date.

Reporting is now considered. Reporting is facilitated by the DOWNLOADCARD PIN Tracking System. This PIN Tracking system will do any number of things, such as, for example: Identify each Web Address (URL) for each PIN Number; Identify each website site a user came from (Referral URL); Track when they came to a (destination) website. Track the response of cards that were known to have been distributed at a particular occasion, e.g. a certain concert.

In accordance with the present invention, one may generate miscellaneous other reports and features. Consider now the Download Activity Log.

In accordance with the present invention, the DOWNLOADCARD host computer keeps an activity log on all downloads made or attempted. For example, for each download attempt, a database record is created, said record comprising information such as: CONTENT ID, CP ID, Referring URL (which download was requested from); Domain name/IP address (which download was requested to)], Date of Download Transaction, PIN number, and, most optionally, a CONTROL NUMBER, the purpose of which is enable further tracking and metrics, and otherwise further the aims of the present invention.

In accordance with the practice of the present invention, database search capabilities may be used on all fields. For but a few examples, note that searching for information by “CONTENT ID” will yield all actual or attempted downloads for a particular bit of content (e.g., a song). (Note that this will not only reveal cardholders with valid PINs, who were able to complete the download, but will also reveal all other (apparently) interested parties who attempted a download but did not enter a valid PIN.

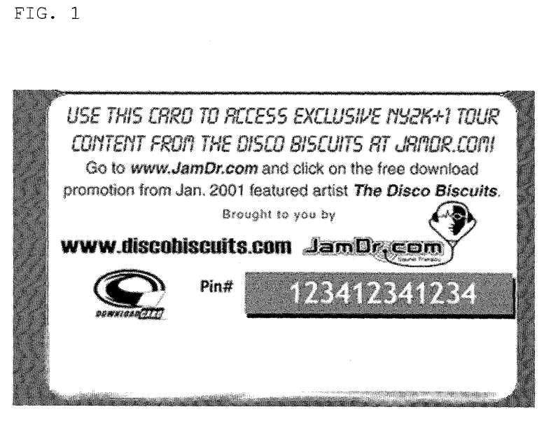

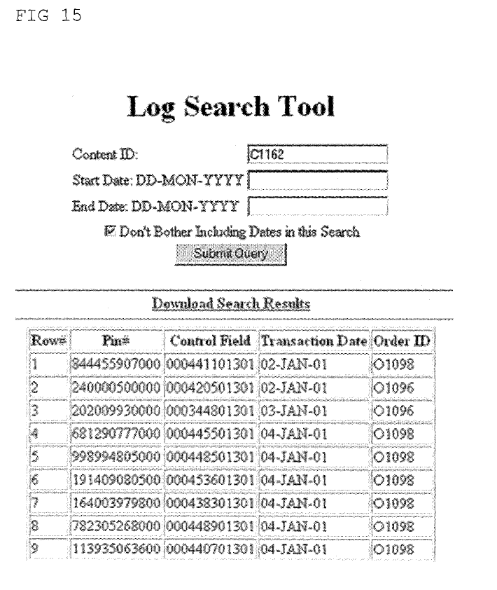

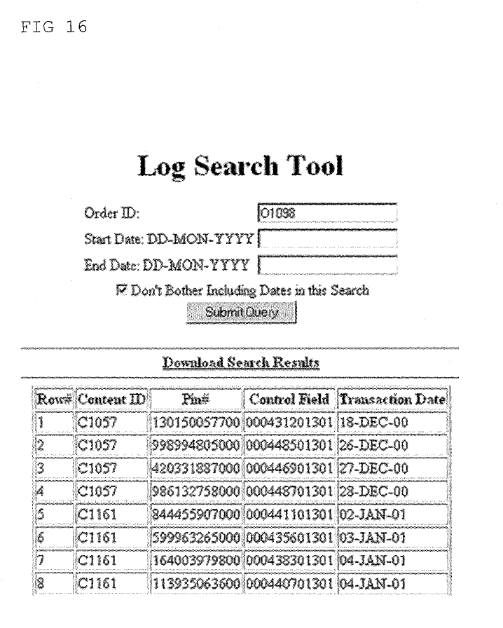

For another example search, one may search for ALL hits associated with a specific CONTENT ID, for an entire Marketing campaign (in other words, the entire campaign to disseminate a given bit of content); this is illustrated in FIG. 1. Another example search would be for data regarding ALL valid PINs entered for a specific CONTENT ID, illustrated in FIG. 15. Yet another example search is a “Search by Order ID from System”; this search will provide information regarding all valid PINS entered for a specific marketing campaign. It is depicted in FIG. 16.

The foregoing detailed description should be regarded as illustrative rather than limiting; for brevity this document does not discuss the many variations which will be apparent to those skilled in the art, and which are rightfully part of the present invention.

We claim:

1. An improved method utilizing PIN numbers for selectively providing digital goods, comprising the steps of:
providing means for a content provider to upload digital goods to a server;
associating a PIN number with said uploaded digital goods,
providing a PIN number to a consumer with a client server,
whereby a consumer can enter the PIN number into the client server and be provided said digital good associated therewith.

2. The method as claimed in claim 1 where the goods are provided by direct download.

3. The method as claimed in claim 1 where the goods are provided by the redirector.

4. An improved system utilizing PIN numbers for selectively providing digital goods, comprising:
means for a content provider to upload digital goods to a server;
means for associating a PIN number with said uploaded digital goods,
means for providing a PIN number to a consumer with a client server,
means for a consumer to enter the PIN number into the client server, whereby
said consumer is provided with said digital good associated therewith.

5. The method as claimed in claim 4 where the means for providing said goods comprise means for direct download.

6. The method as claimed in claim 5 where the means for providing said goods comprise means for direct download.
